(19) United States
(12) Patent Application Publication
(10) Pub. No.: US 2012/0156423 A1
(43) Pub. Date: Jun. 21, 2012

(54) Falling-Film Reactor Fluid Distributors and Methods

(76) Inventors: Philippe Caze, Fountainebleau (FR); Jean-Marc Martin Gerard Jouanno, Painted Post, NY (US); James Scott Sutherland, Corning, NY (US); Robert Stephen Wagner, Corning, NY (US); Pierre Woehl, Strasbourg (FR)

(21) Appl. No.: 13/392,175

(22) PCT Filed: Aug. 31, 2010
(86) PCT No.: PCT/US10/47204

§ 371 Date: Feb. 24, 2012

Related U.S. Application Data
(60) Provisional application No. 61/238,301, filed on Aug. 31, 2009.

(51) Int. Cl. B32B 3/12; B23P 17/04

(52) U.S. Cl. 428/116; 29/890.09

(57) ABSTRACT

A fluid distribution or fluid extraction structure for honeycomb-substrate based falling film reactors is provided, the structure comprising a one or two-piece non-porous honeycomb substrate having a plurality of cells extending in parallel in a common direction from a first end of the substrate to a second and divided by cell walls, and a plurality of lateral channels extending along a channel direction perpendicular to the common direction, the channels defined by the absence of cell walls or the breach of cell walls along the channel direction, the channels being closed or sealed to fluid passage in the common direction but open to the exterior of the structure through one or more ports in a side of the structure, the channels being in fluid communication with the plurality of cells via holes or slots extending through respective cell walls, the holes or slots having a width and a length, the width being equal to or less than the length, and the width at widest being less than 150 μm. Methods of fabrication are also disclosed.

### PRIORITY

This application claims priority to U.S. patent application Ser. No. 61/238301, filed Aug. 31, 2009, titled “FALLING-FILM REACTOR FLUID DISTRIBUTORS AND METHODS”.

### BACKGROUND

The disclosure relates to fluid distributors for falling film reactors and methods for forming them, and more particularly to fluid distributors adapted for use with or within honeycomb monolith substrate based falling film reactors and methods for forming them.

Referring to FIG. 1, gas-liquid falling film reactors have been previously proposed by the present inventors and/or colleagues of the present inventors based on non-porous extruded honeycomb substrates 20 with selective end face machining and plugging. Such devices are disclosed in EP publication no. 2098285, assigned to the present assignee. FIG. 1 shows a cross-sectional view of such a falling film monolith reactor 10, with channels 24 closed by plugs 26 or plugging material 26 defining a heat exchange fluid path 28, typically a serpentine path, and neighboring unplugged channels 22 dedicated to falling film reactions. Liquid reactant 21 applied on or near upper end face plugs forms a thin film 25 as it flows down the inner walls of adjacent unplugged channels 22. Gas reactant 23 flows through the same unplugged channels, enabling a gas-liquid reaction to occur along the entire length of the channels 22. The figure shows counter-current gas flow but co-current flow is also possible. Reactant fluid that collects at the bottom end face of the substrate can be removed by a variety off fluid guiding, wicking or drop formation methods, such as fluid collector 30.

A cross-section view of a falling film reactor assembly 100 with two stacked monolith substrates 20A and 20B is shown in FIG. 2. Liquid reactant 21 is supplied to a distribution zone 29 that forms a ring around the upper end face of the upper monolith substrate 20A. This liquid reactant 21 flows around the distribution zone 29, onto the end face of the monolith substrate 20A, and then down interior channel sidewalls. A spacer monolith 36 is positioned between the two falling film reactor monolithic substrates 20A, 20B to improve reactant flooding performance. Counter-current gas reactant 23 enters at the bottom of the device and exits at the top. Reaction product liquid 21 is collected in a collection structure 30 at the bottom of the device (in this case, a ring-shaped collection structure 30 is used) and removed via one or more tubes 35 attached to the collection structure 30. Monolith substrate temperature is controlled by introducing heat exchange fluid 37 through side-mounted ports 38. Various o-ring seals 39A and epoxy seals 39B cooperate the collection structure 30 and with cylinders 39C and an end plate 39D, preferably of stainless steel, to complete the assembly.

Rapid exothermic reactions within a falling film reactor can lead to explosions. The heat-exchange channels in the form of the closed channels 24 are positioned in close proximity to falling film reaction channels 22 to help prevent run-away thermal reactions. Some gas-liquid falling film reactors may be used with flammable liquid reactants and/or reaction products, while others may generate flammable or explosive chemical byproducts, liquid or gas. If combustion of these materials is initiated by a spark (via static electricity, for instance) a ripple effect may lead to rapid combustion throughout the entire reactor. Depending on how much heat is given off in the combustion reaction, an explosion may lead to destruction of the reactor and/or risk of injury.

Propagation of combustion flame fronts through frame barrier structures can be prevented as long as the size of flame barrier internal passageways does not exceed a maximum value. Flame barriers can be formed using fine mesh metal screens or inorganic or metallic materials with maximum open porosity on the order of 75-150 um. With reference to FIG. 3, the present inventors and/or their colleagues have previously described flame barrier screens 84 that may be applied to each monolith substrate end face to prevent flame propagation.

A challenge with use of this type of flame barrier screen 84 is introduction of liquid reactants 21A into the falling film reaction channel 22 without wetting the flame barrier screen 84. The concern is that if the flame barrier screen 84 becomes excessively wetted by liquid reactants 21 as they enter the reaction channel 22, a liquid barrier may under certain conditions form across the screen 84. This liquid barrier may hamper the formation of a uniformly thick falling film in the reaction channel 22. The same challenge exists at the lower end face of the monolith substrate where gas-liquid separation takes place. If liquid reaction product 21B contacts the flame barrier screen 84 the presence of the liquid 21B on the screen 84 may interfere with the uniform flow of gas reactants 23 through the reaction channels 22.

### SUMMARY

One embodiment is a fluid distribution or fluid extraction structure for honeycomb-substrate based falling film reactors, the structure comprising a one or two-piece non-porous honeycomb substrate having a plurality of cells extending in parallel in a common direction from a first end of the substrate to a second and divided by cell walls, and a plurality of channels extending along a channel direction perpendicular to the common direction, the channels defined by the absence of cell walls or the breach of cell walls along the channel direction, the channels being closed or sealed to fluid passage in the common direction but open to the exterior of the structure through one or more ports in a side of the structure, the channels being in fluid communication with the plurality of cells via holes or slots extending through respective cell walls, the holes or slots having a width and a length, the width being equal to or less than the length, and the width at widest being less than 150 μm.

A further embodiment includes a method of forming a fluid distribution or fluid extraction structure, the method comprising providing a honeycomb substrate; breaching selected walls of the honeycomb substrate so as to form one or more channels perpendicular to the direction of the cells of the honeycomb substrate; forming slots or holes through sidewalls of the one or more channels; sealing above and below at least a portion of the slots or holes such that the one or more channels become one or more internal channels accessible through the slots or holes; and providing access to the one or more internal channels from the exterior of the substrate. The slots or holes have a width and a length, the width being equal to or less than the length, and the width at widest being less than 150 μm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1-3 are a cross-sectional views embodiments of a honeycomb-substrate based falling film reactor or reactor assembly previously proposed by the present inventors and/or their colleagues;

FIG. 4 is one alternative embodiment of fluid distributors useful for a honeycomb-substrate based falling-film reactor;

FIGS. 5A-5C are perspective schematic views showing certain steps in the formation of a fluid distributor useful for a honeycomb-substrate based falling-film reactor;

FIGS. 6A-6B are perspective schematic views showing certain alternative steps in the formation of a fluid distributor useful for a honeycomb-substrate based falling-film reactor;

FIG. 7 is a diagrammatic cross-sectional view of a honeycomb substrate based falling film reactor assembly including fluid distributors prepared as in FIG. 5 or 6.

FIG. 8 is a diagrammatic cross-sectional view of an alternative embodiment of the honeycomb substrate based falling film reactor assembly including fluid distributors of FIG. 7.

FIGS. 9 and 10 are perspective schematic views showing certain additional alternative steps in the formation of a fluid distributor useful for a honeycomb-substrate based falling-film reactor;

FIG. 11 is a close-up perspective view of a portion of an endface of an extruded substrate useful in the context of the present invention;

FIG. 12 is a diagrammatic cross-sectional view of an alternative embodiment of the honeycomb substrate based falling film reactor assembly including fluid distributors of the type of FIGS. 9 or 10 and 11.

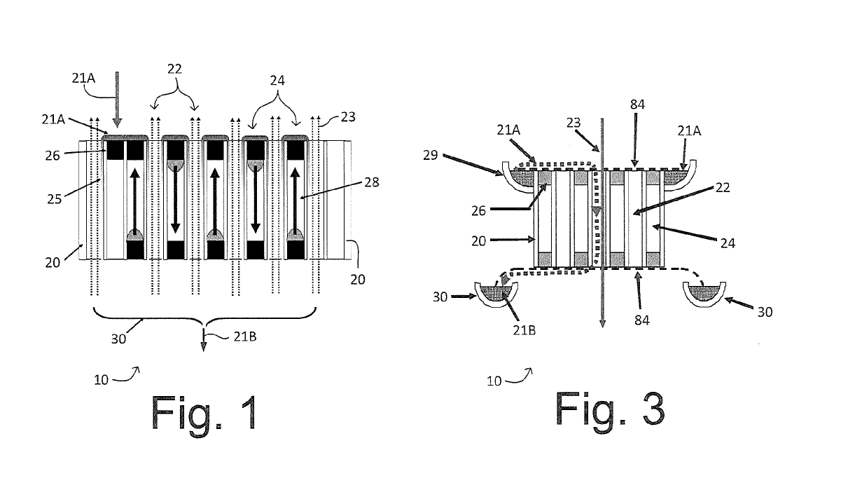

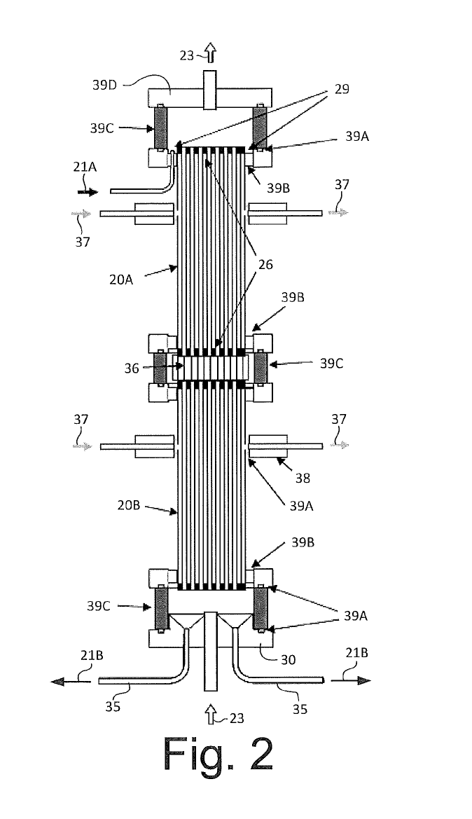

### DETAILED DESCRIPTION

The following description provides details of some embodiments of the present invention. Like features will generally be referred to with the same or similar reference characters across all of the figures herein.

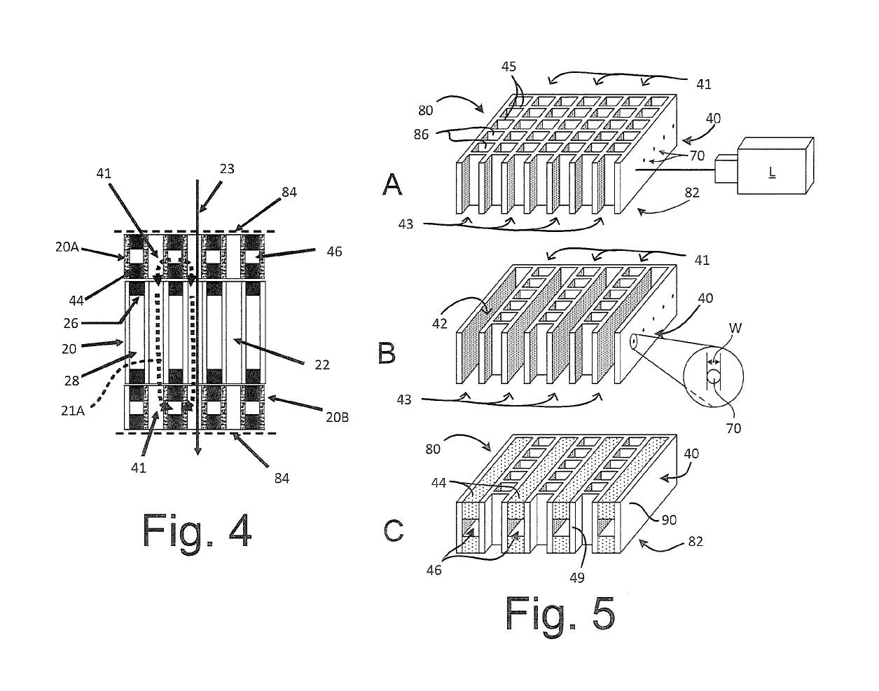

FIG. 4 shows the present inventors and/or their colleagues have developed porous monolith substrates 20A, 20B that can be integrated with a non-porous falling film monolith substrate 20 to provide fluid distribution and liquid reaction product collection. One porous monolith substrate 20A is mounted on the upper end face of the non-porous monolith substrate 20 with its axial internal cells 41 aligned with the non-porous substrate falling film reaction channels 22. A flame barrier screen 84 is positioned on top of the porous monolith substrate 20A to prevent unwanted flame propagation between reaction channels 22. A similar substrate 20B is employed on the lower face of the substrate 20.

Liquid reactant 21A flows into the porous monolith substrate 20A through lateral internal channels 46 defined in part by non-porous plugs 44. The fluid is fed to channels 46 via an internal or external fluid manifold (not shown in the cross section of the figure). The liquid reactant 21A flows through the porous walls of the monolith substrate 20A, forms a thin film on the sidewalls of the axial internal channels 41, and then flows downward into the non-porous monolith substrate falling film reaction channel 22. While this type of fluid distributor has many advantages, a potential challenge in this approach is that cells of the porous monolith substrate 20A must be well-aligned to cells of the nonporous monolith substrate 20. Since monolith substrate cells sometimes experience distortion in extrusion and/or sintering it may be difficult to make cells in two different monolith substrates 20A, 20 line up with each other.

The present disclosure accordingly focuses on improved honeycomb-extrusion based falling film reactor fluid distribution and collection structures, particularly those having improved registration or fit with an associated reactor, and low-cost fabrication methods for providing such structures. Throughout this document references made to fluid distributors at the top of a monolith-substrate-based falling film reactor will also be assumed to apply to fluid collectors at the bottom of the substrate. These structures can be formed using non-porous monolithic substrates mated with other non-porous falling film monolith substrates, or, in an alternative embodiment, can be integrated into the same substrate that houses the reaction channels. In both cases non-porous plugs are desirably used to confine fluids within the distribution structures. Improved fluid distribution channels and flame barriers can also be integrated into these structures, as will be shown below.

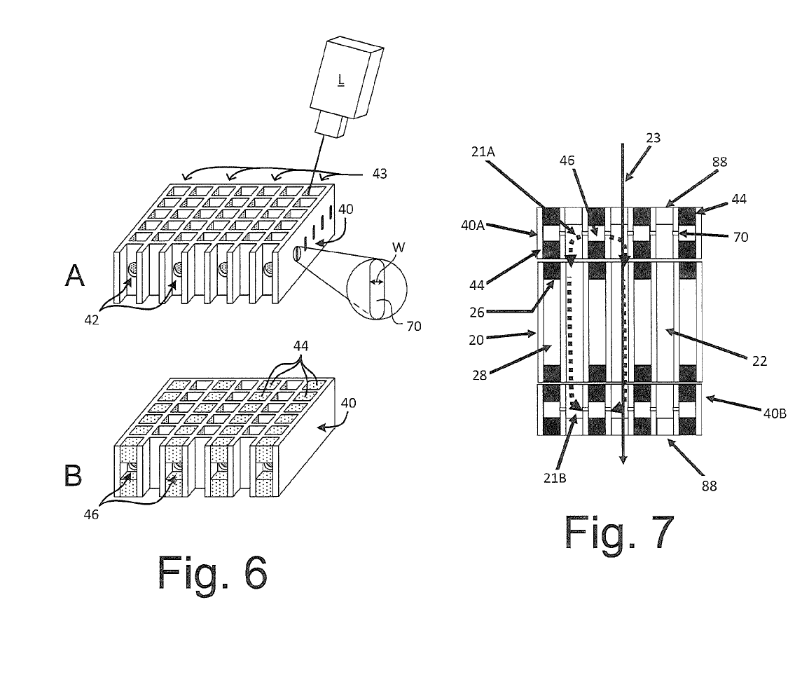

Reference will now be made in detail to the accompanying drawings which illustrate certain instances of the methods and devices described generally herein. Whenever possible, the same reference numerals will be used throughout the drawings to refer to the same or like parts. One embodiment of a falling film reactor with fluid distributors is shown in FIG. 7, and is designated generally throughout by the reference numeral 10. FIGS. 5A-5C and 6A-6B show various alternative methods of providing fluid distributors for the reactor 10 of FIG. 7.

To substantially avoid difficulties in aligning cells on mated fluid distributor and falling film reactor substrates 20A and 20, the substrates 20A and 20 can be fabricated from adjacent portions of a single extruded log. To maintain alignment during shrinkage that normally occurs during sintering both substrates are then sintered in identical conditions so that they are both non-porous. As another option, the full desired length of reactor plus fluid distributor(s) may be sintered as one piece, and then sawed apart. The following describes various techniques for incorporating fluid distribution and flame barrier structures into the resulting non-porous distributor structures.

FIGS. 5A-5C, are perspective views of certain steps in the preparation fluid distributors for honeycomb-based falling film reactors. Initially a honeycomb substrate 40 is provided, such as by forming via extrusion or other suitable means, and then desirably kept in the green state through the steps shown in FIGS. 5A and 5B, although these steps may also be performed after final firing or sintering. The substrate 40 has multiple channels 86 extending through the substrate 40 from a first end 80 to a second end 82 thereof and is non-porous, or at least non-porous after final firing or sintering. Methods and materials for producing such bodies are known in the art of ceramic honeycomb extrusion. Suitable materials can include, but are not limited to, cordierite, aluminum titanate, silicon carbide, alumina, and so forth.

The substrate 40 is preferably of relatively thin but uniform thickness in the direction of the channels from the first end 80 to the second end 82. For example, the substrate may be in the range of 3-15 mm thick, more preferably about 5-8 mm thick. A green extruded substrate may be relatively easily sawn to a size in this range, for example.

Desirably (but not necessarily in every instance) while the substrate 40 is still in the green state, selected cell walls 45, in this case those positioned between cells of the odd numbered rows 43, are breached so as to join selected ones of channels 86 so as to produce one or more open lateral passages 42 extending in a direction crossways to the direction of the channels. Breaching may be performed, for example, by removing the walls by machining them away, as shown in FIG. 5B. Machining may be performed in any suitable manner, such as wire saw cutting, laser cutting, water jetting, or the like. Alternatively, breaching may be performed by drilling holes 200 through the row, as shown in FIG. 6A. Removing walls as in FIG. 5B can allow for complex patterns, but drilling as in FIG. 6A may be preferred for ease of execution, if the depth of drilling required is not too deep. In either case, selected ones of the channels 86 are thus joined by the breached walls, so as to produce one or more open lateral passages 42 extending in a direction crossways to the direction of the channels, as shown in FIGS. 5B and 6A. In the embodiments shown in FIGS. 5A-5C and 6A-6B, the lateral passages 42 are formed in the odd numbered rows 43. Machining can be used remove cell walls completely, as shown in FIG. 5B, or may only remove walls to a significant degree, such as 60-80%, leaving shortened walls in place (not shown) if needed to help preserve the stability of the extruded substrate 40, or for any other desirable reason.

Either before or after breaching, microchannels 70 are machined through the sidewalls 49 that divide the lateral passages 42 from the axial internal cells or channels 41. This machining may be performed by a laser L with the extruded substrate 40 in the green state or in the sintered state. The beam size and motion of the laser L are selected such that the width W of the microchannels 70 is not greater than 150 micrometers, desirably not greater than 100 micrometers, and most desirably, for some applications, not greater than 50 micrometers.

As depicted generally by the alignment of the laser L in FIG. 5A, the laser machining of microchannels 79 may be carried out from the side of the substrate 40, and may open microchannels through all of the walls laterally across the honeycomb structure (with microchannels inside the honeycomb not visible in perspective view of FIG. 5). The outermost microchannels, such as those visible in FIGS. 5A and 5B, are later filled so that no microchannel access to the exterior side 90 of the substrate 40 remains, as in FIG. 5C. As depicted generally in FIG. 6A, the microchannels 70 need not be round, but may be oblong as shown. Also as a further alternative, the microchannels 70 do not have to be machined by a laser from the side of the substrate 40. They can also be formed, particularly if oblong, by a steep-angle laser beam tilted roughly as shown by the (optional) position of laser L in FIG. 6A. Thus in this optional embodiment the outside wall 90 is never machined so subsequent plugging is not required, although a larger number of laser cuts is required, since multiple dividing walls 45 are not machined at once.

Where the microchannels are not round, but have a length (greatest dimension) and a width (lesser dimension), the largest width should be no more than 150 micrometers, desirably not greater than 100 micrometers, and most desirably, for some applications, not greater than 50 micrometers.

Either before or after machining microchannels 70, the lateral passages 42 are plugged at the top and bottom thereof with a non-porous plugging material 44, as shown in FIGS. 5C and 6B. The plugs 26 or plugging material 26 may be positioned level with the top and bottom ends 80 and 82 of the substrate 40, and have plugging depth set relative to each other such that enclosed lateral passages 46 are formed between the respective opposing walls of the substrate 40 and the respective upper and lower plugs 44 within the (formerly open) lateral passages 42. As mentioned the substrate 40 is desirably an extruded green substrate, and as such may be plugged before sintering using green plugs, or after sintering using post-sinter-CTE matched organic plugs or inorganic epoxy plugs. Cells above falling film channels may optionally be plugged with porous plug material 88 or porous plugs 88 (shown in FIG. 7, but not in FIGS. 5 and 6) to also serve as a flame barrier. After the non-porous fluid distributor is plugged it is aligned and attached to the upper surface of the falling film reactor. The resulting reactor is shown in diagrammatic cross section in FIG. 7. Reactant liquid 21A flows from lateral internal channels 46 in the substrate 40A through machined microchannels 70 into the reaction channels or open cells 22 of the main monolith substrate 20. Product liquid 21B is removed in similar fashion by substrate 40B by means of overpressure in the cells 22 or partial vacuum in the lateral internal channels of substrate 40B.

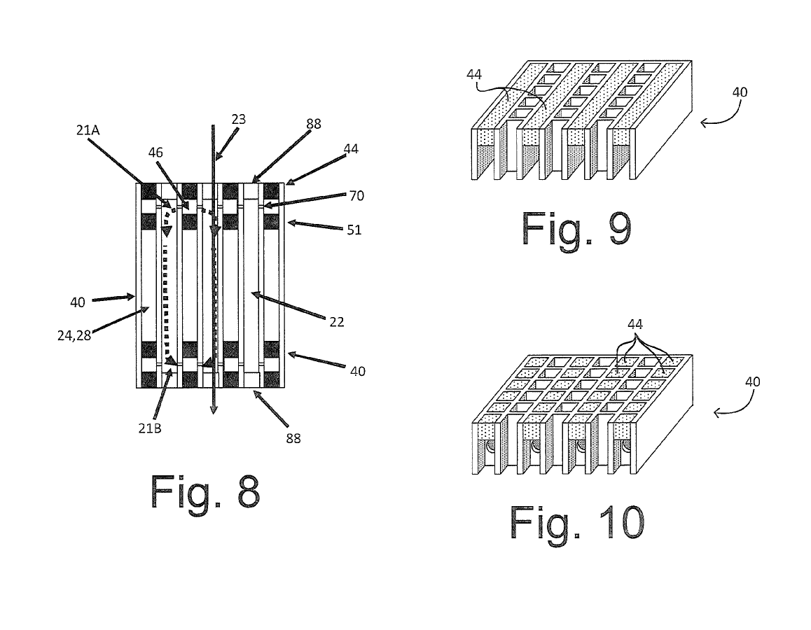

As mentioned above, a non-porous substrate fluid distributor may also be integrated with a falling film reactor substrate in one extruded substrate. The laser machining process for fabricating non-porous fluid distributor sidewall microchannels can also be applied to the falling film substrate. In this case the separate distributor substrate (40A) is eliminated and all processing takes place on the central substrate of the falling film substrate 40, 20. As with the previous example a laser is directed at the non-porous substrate sidewall from the side, above or below to form one or more microchannels of the preferred size(s) mentioned above so as both pass fluid and prevent flame propagation. FIG. 8 shows two sets of non-porous plugs applied above and below fluid distribution channels within the falling film substrate. The upper non-porous plugs 44 can be applied directly via a plug masking process. The lower non-porous plugs 51 can be fabricated by inserting an injection needle into the respective channel and completely filling a portion of the channel with plug material.

This approach has the advantage that the fluid distributor and collector are integrated into the falling film substrate. Therefore it eliminates the step of joining any fluid distributor and collector substrates to the falling film substrate. The main challenge is that fabrication of the deep non-porous plugs involves a plug injection process that is most likely carried out serially over each end face. In a production-grade process plug injection could be performed more rapidly by providing multiple injectors so plugs can be injected at multiple locations on the substrate end face simultaneously.

In the previous non-porous fluid distributor approach microchannels were formed by directly a laser through selected walls of the falling film substrate. A similar microchannel structure for fluid distribution can be created by joining a separate distributor substrate with a falling film substrate as shown and described below with respect to FIGS. 9-12. In the approach shown in FIGS. 9-12, the fluid distribution channel and flame barrier are formed by the union of the distributor substrate 40A and falling film substrate 40. First a fluid distributor similar to that in FIG. 5C is prepared, but without the lower plugs, resulting in the structure shown in FIG. 9. Alternatively, a fluid distributor similar to that in FIG. 6B may be prepared, but again without the lower plugs, resulting in the structure shown in FIG. 10.

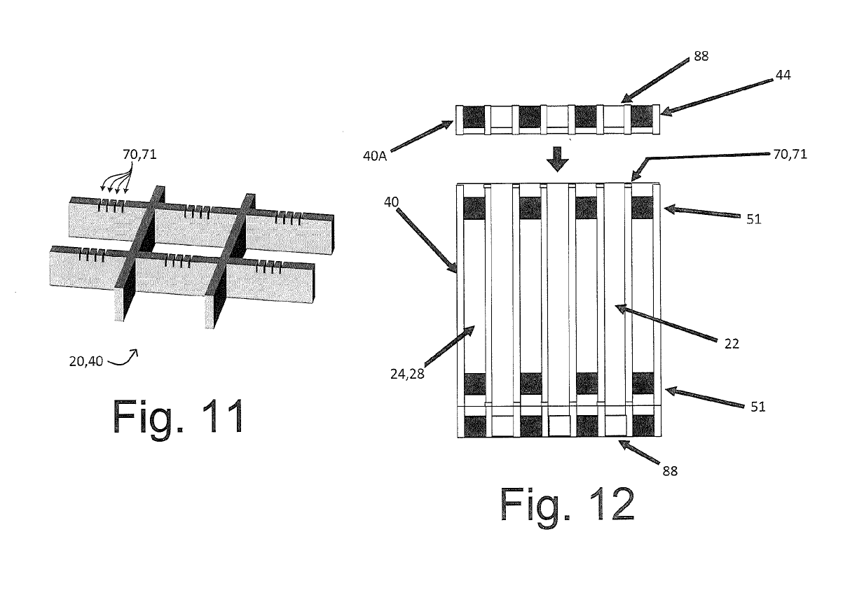

To create the microchannels 70 required for fluid transport from fluid distributor channels 46 to the falling film channels 22, narrow slots or trenches 71 are selectively machined at the distributor substrate/falling film substrate interface on the distributor substrate and/or falling film substrate, as shown in the magnified partial perspective view of FIG. 11. FIG. 11 shows an example of narrow slots 71 selectively formed on a portion of an end face of a distributor substrate 40 or of a reactor substrate 20. The narrow slots 71 can be mechanically machined via a precision dicing saw or formed via laser ablation. In both cases slots that are 50-150 um wide can be formed in the substrate walls. Experiments show that green substrate material is relatively easy to machine via mechanical sawing or laser ablation. Precision microstructures formed using these techniques are well-preserved during sintering. Sintered ceramic can also be machined, if not quite as easily.

Once narrow slots 71 are selectively micromachined into the distributor and/or falling film substrates, porous plugs 88 and non-porous plugs 44, 51 are applied to the distributor as shown in FIG. 12. Non-porous plugs 51 are also selectively applied to the falling film substrate. These non-porous plugs prevent leakage of heat exchange from the falling film substrate, and also guide fluid within the distributor after assembly.

Next the distributor substrate 40A is mounted on the falling film substrate 40, aligned and then attached using chemically-resistant adhesive or pressure via an externally applied clamping approach. The narrow slots 71 form through-holes or microchannels 70 that are no more than 50-150 um wide. The small channel size enables fluid transport to the falling film channels while preventing flame propagation.

In an alternative approach the separate distributor substrate can be eliminated if the depth of the machined slots can be made to exceed the typical plugging depth. The resulting structure appears similar to the one shown in FIG. 8, but with a machined slot that extends from the end face of the substrate to the location where the micromachined microchannel 70 is shown in the figure. The plug material will only plug portions of the slot that are close to the substrate end face, leaving the portions of the slot closer to the center of the falling film substrate unplugged for fluid transport. This also requires double plugging, where the fluid distribution channels are defined by an upper and lower plug. Experimental

Laser ablation of narrow trenches in green alumina substrate end face walls has been demonstrated under a variety of laser conditions. In one experiment a 6 mm thick slice sample from a 2″ diameter green 200/12 alumina substrate was mounted on a laser translation stage. A scanning laser beam system above the sample directed a focused laser beam downward upon the exposed edges of substrate channel walls. When operating, the laser beam is scanned along a linear path one or more times at a user-defined velocity.

In another laser experiment trenches as narrow as ˜30 um were fabricated in alumina using a Lumera Picosecond laser (355 nm wavelength, ˜20 um spot using 100 mm F-Theta lens, 100 kHz repetition rate, 10 cm/sec sweep speed). Laser cutting produced very clean cuts with no evidence of thermal damage.

The methods and/or devices disclosed herein are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydro formylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quatemization; formylation; phase transfer reactions; silylations; nitrile synthesis; phosphorylation; ozonolysis; azide chemistry; metathesis; hydrosilylation; coupling reactions; and enzymatic reactions.

It will be apparent to those skilled in the art that various modifications and variations can be made without departing from the spirit or scope of the invention.

1. A falling film reactor fluid distribution or fluid extraction structure, the structure comprising a one or two-piece non-porous honeycomb substrate having a plurality of cells extending in parallel in a common direction from a first end of the substrate to a second and divided by cell walls, and a plurality of channels extending laterally along a channel direction perpendicular to the common direction, the channels defined by the absence of cell walls or the breach of cell walls along the channel direction, the channels being closed or sealed to fluid passage in the common direction but open to the exterior of the structure through one or more ports in a side of the structure, the channels being in fluid communication with the plurality of cells via holes or slots extending through respective cell walls, the holes or slots having a width and a length, the width being equal to or less than the length, and the width at widest being less than 150 μm.

2. The structure according to claim 1 wherein the width at widest of the holes or slots is less than 100 μm.

3. The structure according to claim 1 wherein the width at widest of the holes or slots is less than 50 μm.

4. The structure according to claim 1 wherein the channels are closed or sealed by plugs at both the first and second ends of the substrate.

5. The structure according to claim 1 wherein the channels are closed or sealed by plugs at the first end of the substrate and by the substrate being joined to a matching end-face plugged honeycomb structure at the second end of the substrate.

6. The structure according to claim 1 wherein the channels are closed or sealed by plugs at the first end of the substrate and by plugs below the channel, the plugs below the channel being nearer to the first end of the substrate than to the second end.

7. A method of forming a falling film reactor fluid distribution or fluid extraction structure, the method comprising:
providing a honeycomb substrate;
breaching selected walls of the honeycomb substrate so as to form one or more lateral channels perpendicular to the direction of the cells of the honeycomb substrate;
forming slots or holes through sidewalls of the one or more channels;
sealing above and below at least a portion of the slots or holes such that the one or more channels become one or more internal channels accessible through the slots or holes; and
providing access to the one or more internal channels from the exterior of the substrate,
wherein the slots or holes have a width and a length, the width being equal to or less than the length, and the width at widest being less than 150 μm.

8. The method according to claim 7 wherein the width at widest of the holes or slots is less than 100 μm.

9. The method according to claim 7 wherein the width at widest of the holes or slots is less than 50 μm.

10. The method according to claim 7 wherein the step of forming comprises cutting into an exposed endface of an extruded substrate.
